(19) United States
(12) Patent Application Publication
(10) Pub. No.: US 2003/0164392 A1
(43) Pub. Date: Sep. 4, 2003

(54) Wrap dispenser with enhanced cutter bar registration

(76) Inventor: Kristopher W. Gerulski, Racine, WI (US)

Correspondence Address: Kristin L. Chapman, Esq., S.C. Johnson Home Storage, Inc., 1525 Howe Street, Racine, WI, 53403-2236, US

(21) Appl. No.: 10/087,292

(22) Filed: Mar. 1, 2002

(51) Int. Cl. B26F 3/00

(52) U.S. Cl. 225/1; 225/43; 225/48

(57) ABSTRACT

A dispenser for rolls of wrap material is disclosed. The wrap dispenser may include a trunk to which a lid is integrally hinged. The trunk is adapted to receive a roll of wrap therein, while the lid is adapted to move relative to the trunk to allow access to the rolled film. A portion of the dispenser is provided with a reinforced section to which a cutter bar is adhered. The cutter bar may be manufactured from plastic and be attached to the dispenser such that teeth of the cutter bar are all exposed upon opening the dispenser.

### FIELD OF THE DISCLOSURE

The disclosure generally relates to food storage wraps and, more particularly, relates to dispensers for food storage wraps.

### BACKGROUND OF THE DISCLOSURE

Wrap dispensers are well-known. Such dispensers are typically provided in the form of a trunk-lid box manufactured from paperboard or the like, wherein a trunk or base of the container houses a roll of film to be dispensed, and a lid, integral with the trunk, is hinged so as to allow access to the roll. The rolls of film can be provided in a variety of forms including, but not limited to, plastic film, aluminum foil, parchment paper, and waxed paper.

In association with such trunk-lid boxes, cutter bars are typically provided to enable the film to be easily torn from the roll. The cutter bars themselves are provided in a variety of forms as well. For example, the cutter bars are preferably tailored so as to optimize the efficiency and efficacy with which the cutter bar is able to cut the film. Using aluminum foil as an example, it is often adequate to simply provide a straight-edged blade to enable the foil to be cut. However, plastic films, given that they can be constructed from a variety of polymeric compounds and structures, often require blades which include a plurality of teeth extending therefrom. Not only are teeth provided, but it is known to optimize the spacing, size, and pitch of the teeth so as to enable the film to be most effectively torn.

Physical placement of the cutter bar on the trunk-lid box is also of importance. Conventionally, such cutter bars are provided on the bottom surface of the trunk such that the film is dispensed by pulling the desired length from the roll, and moving the film downwardly while pulling the trunk-lid box upwardly. The user therefore is required to pull the wrap down relative to the carton when severing the film. Moreover, the molecular structure of some films lend themselves to more effective dispensing if torn in such a direction.

It is also known to provide cutter bars on an inside surface of the front flap of the trunk-lid. The films are therefore dispensed by pulling a desired length from the roll, and pulling upwardly on the film while moving the trunk-lid dispenser downwardly. While effective, the trunk flap of the lid is often not as structurally fortified as the base, and can thus tend to bow or otherwise deflect during dispensing. This is particularly so in the event that a non-metallic cutter bar is employed. More specifically, metallic cutter bars are typically more structurally rigid than their plastic counterparts, and thus can lend some level of fortification to the trunk-lid if employed.

### SUMMARY OF THE DISCLOSURE

In accordance with one aspect of the disclosure, a wraps dispenser is provided which comprises a trunk, a lid hinged to the trunk and a cutter bar. The cutter bar includes a base from which a plurality of teeth extend, with each tooth terminating on first and second sides at a valley proximate the base. The base is attached to one of the trunk and the lid, with each valley being spaced away from the trunk or the lid to which the base is attached by a predetermined registration zone.

In accordance with one aspect of the disclosure, a wraps dispenser is provided which comprises a trunk and a lid hinged to the trunk. The trunk is adapted to receive a roll of wrap therein, while the lid includes a front flap to which a cutter bar is attached. The front flap of the lid is thicker than the trunk and remaining portions of the lid.

In accordance with another aspect of the disclosure, a method of forming a wraps dispenser is provided which comprises the steps of providing a template having a plurality of lid flaps, folding at least one of the lid flaps to form a reinforced section, attaching the folded lip flap, and folding the flaps into a tubular configuration. The template includes a plurality of lid flaps adapted to form a lid, and a plurality of trunk flaps adapted to form a trunk. The folding step is performed so as to fold one of the lid flaps over parallel to another of the lid flaps. The adhering step is performed such that the folded lid flap is made parallel to the other lid flap, thereby forming a double-layered lid front. The tubular configuration includes first and second open ends adapted to receive a roll of film therein.

In accordance with yet another aspect of the disclosure, a wraps dispenser is provided which comprises a trunk, a lid, a cutter bar, and means for reinforcing. The trunk is adapted to receive a roll of film, while the lid is hinged to the trunk and adapted to close the trunk. The cutter bar is attached to the dispenser. The means for reinforcing the dispenser is provided proximate the cutter bar.

In accordance with another aspect of the disclosure, a wraps dispenser is provided which comprises a trunk, a lid, a reinforcing member, a tear strip, and a cutter bar. The trunk includes a base, a back wall, a front wall, and first and second end walls while the lid is hinged to the trunk and includes a front wall, a top wall, and first and second end walls. The reinforcing member is operatively associated with the trunk and front wall and the tear strip is removably attached to the lid front wall at a score line. The cutter bar is attached to the reinforcing member and includes a plurality of teeth separated by a plurality of valleys. The plurality of teeth overlie the tear strip while the plurality of valleys each are spaced from the score line by a registration zone of predetermined dimension.

These and other aspects and features of the disclosure will become more apparent upon reading the following detailed description when taken in conjunction with the accompanying drawings.

### BRIEF DESCRIPTION OF THE DRAWINGS

FIG. 1 is an isometric view of a wraps dispenser constructed in accordance with the teachings of the disclosure, and depicted in an open configuration;

FIG. 2 is an isometric view of a wraps dispenser constructed in accordance with the teachings of the disclosure, and depicted in a closed, unopened position;

FIG. 3 is a sectional view of the wraps dispenser of FIG. 2, taken along the line 3-3 of FIG. 2;

FIG. 4 is a plan view of a template used in constructing the wraps dispenser;

FIG. 5 is a fragmentary plan view of the template after being folded to create a double-walled trunk lid;

FIG. 6 is a perspective view of an alternative embodiment of a wraps dispenser constructed in accordance with the teachings of the disclosure;

FIG. 7 is a sectional view of the dispenser of FIG. 6 taken along the line 7-7 of FIG. 6;

FIG. 8 is a plan view of a template used in constructing such an alternative embodiment;

FIG. 9 is a fragmentary plan view of the template of the alternative embodiment after being folded to create a double walled trunk lid;

FIG. 10 is a fragmentary plan view of folded template of FIG. 9 with a cutter bar attached;

FIG. 11 is a plan view of a stock sheet from which a plurality of templates can be produced;

FIG. 12 is a flow chart depicting a sample sequence of steps which may be taken in constructing a dispenser according to the method of the present disclosure, and

FIG. 13 is an isometric view of a second alternative embodiment of a dispenser constructed in accordance with the teachings of the disclosure; and

FIG. 14 is a plan view of a cutter bar constructed in accordance with the teachings of the disclosure.

While the disclosure is susceptible to various modifications and alternative constructions, certain illustrative embodiments thereof have been shown in the drawings and will be described below in detail. It should be understood, however, that there is no intention to limit the disclosure to the specific forms disclosed, but on the contrary, the intention is to cover all modifications, alternative constructions, and equivalents falling within the spirit and scope of the disclosure as defined by the appended claims.

### DETAILED DESCRIPTION OF THE DISCLOSURE

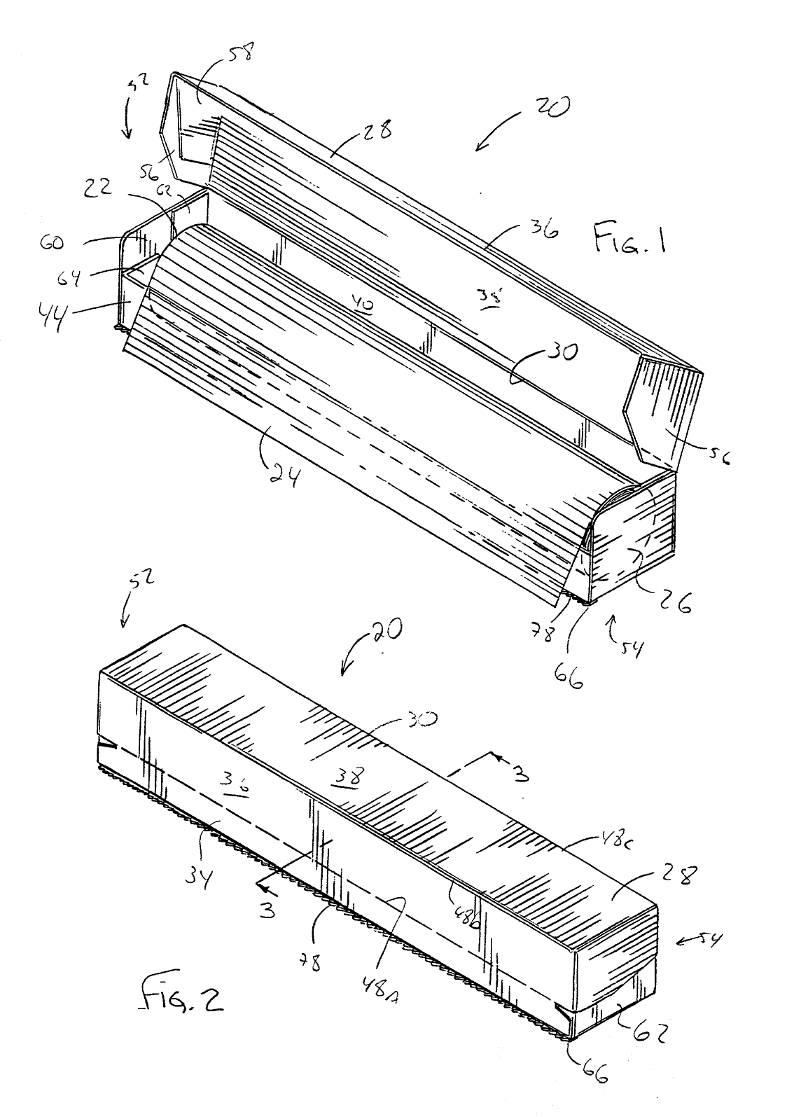

Referring now to the drawings, and with more specific reference to FIG. 1, a wraps dispenser constructed in accordance with the teachings of the disclosure is generally referred to by reference numeral 20. While the dispenser 20 is depicted and described in further detail herein in conjunction with a roll 22 of thermoplastic film 24, and as being manufactured from paperboard, it is to be understood that the teachings of the disclosure can be employed in constructing dispensers 20 of alternative materials including other cellulosic and plastic materials, and for dispensing other wraps including, but not limited to, other plastic films, metallic films, and paper wraps.

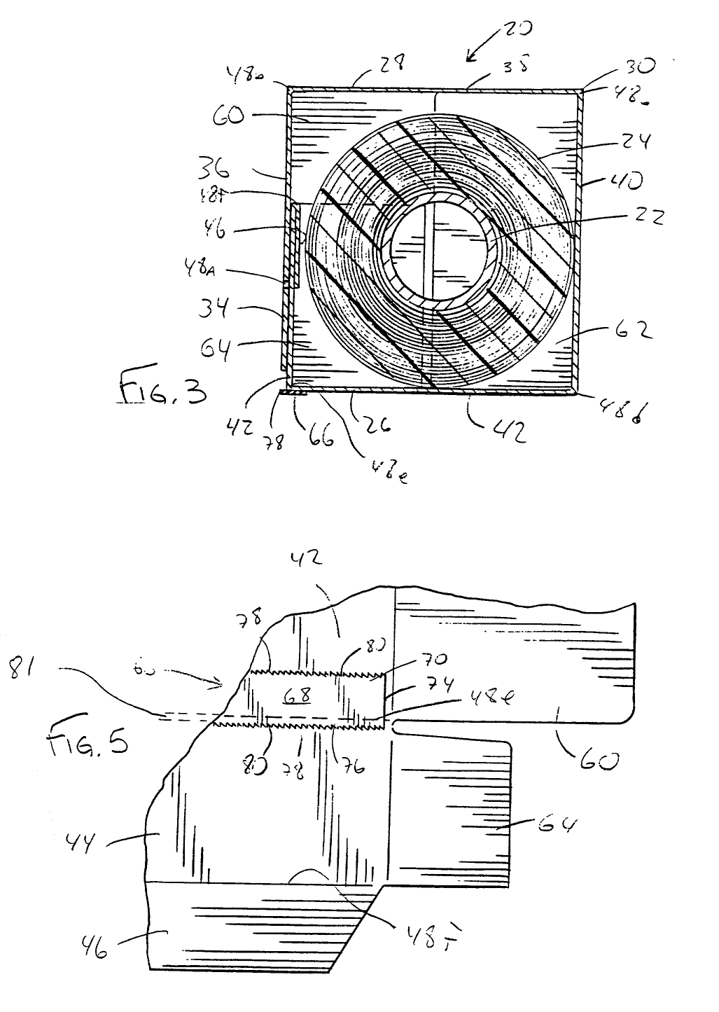

As shown in FIGS. 1-3, the dispenser 20 generally includes a trunk or base 26 to which is hinged a lid 28. The base 26 and lid 28 are preferably manufactured from a unitary piece of material and connected at a fold 30 to enable the lid 28 to pivot relative to the trunk 26 and thereby allow access to the roll 22.

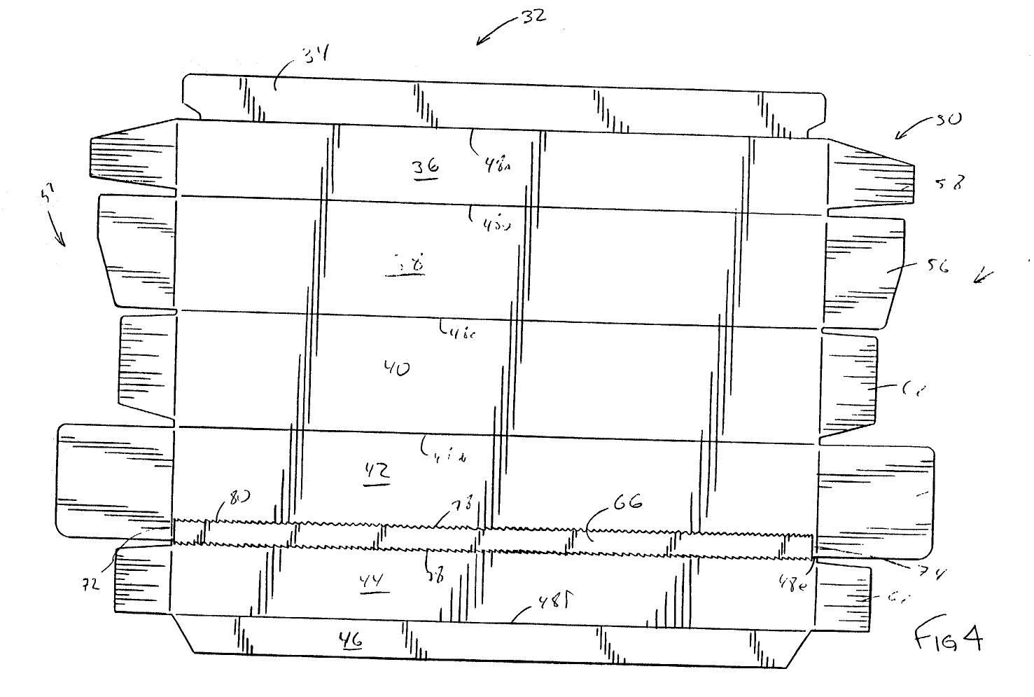

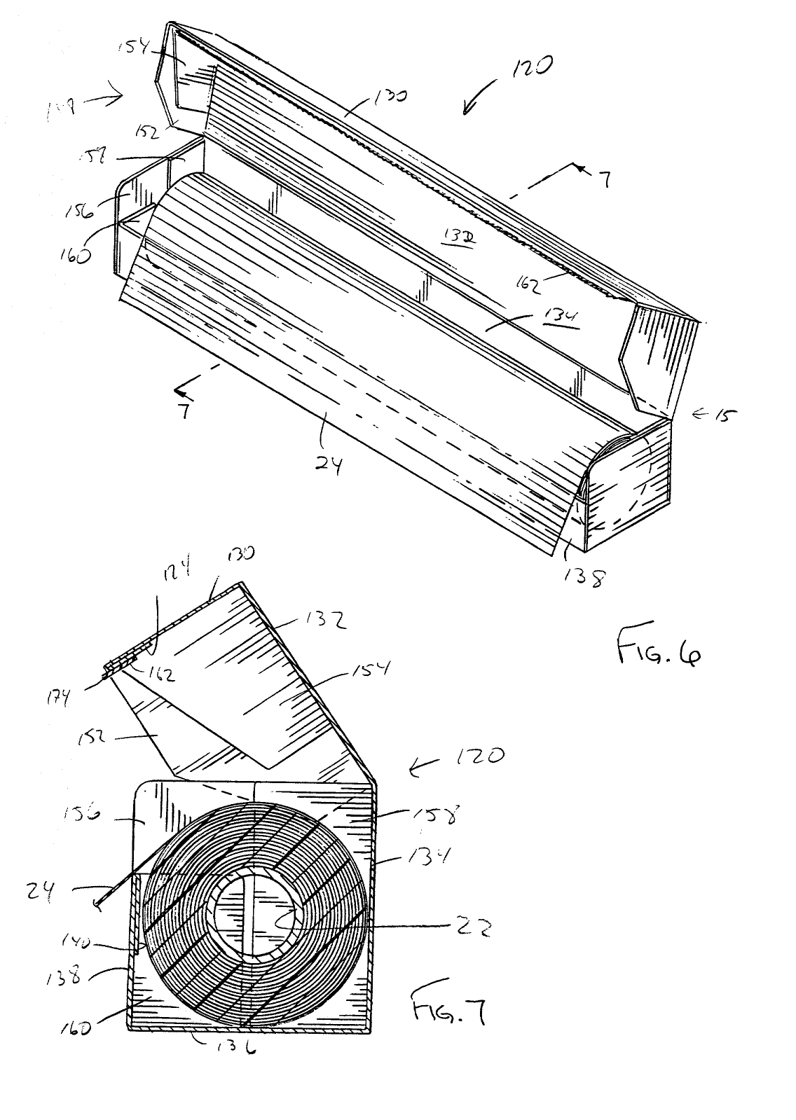

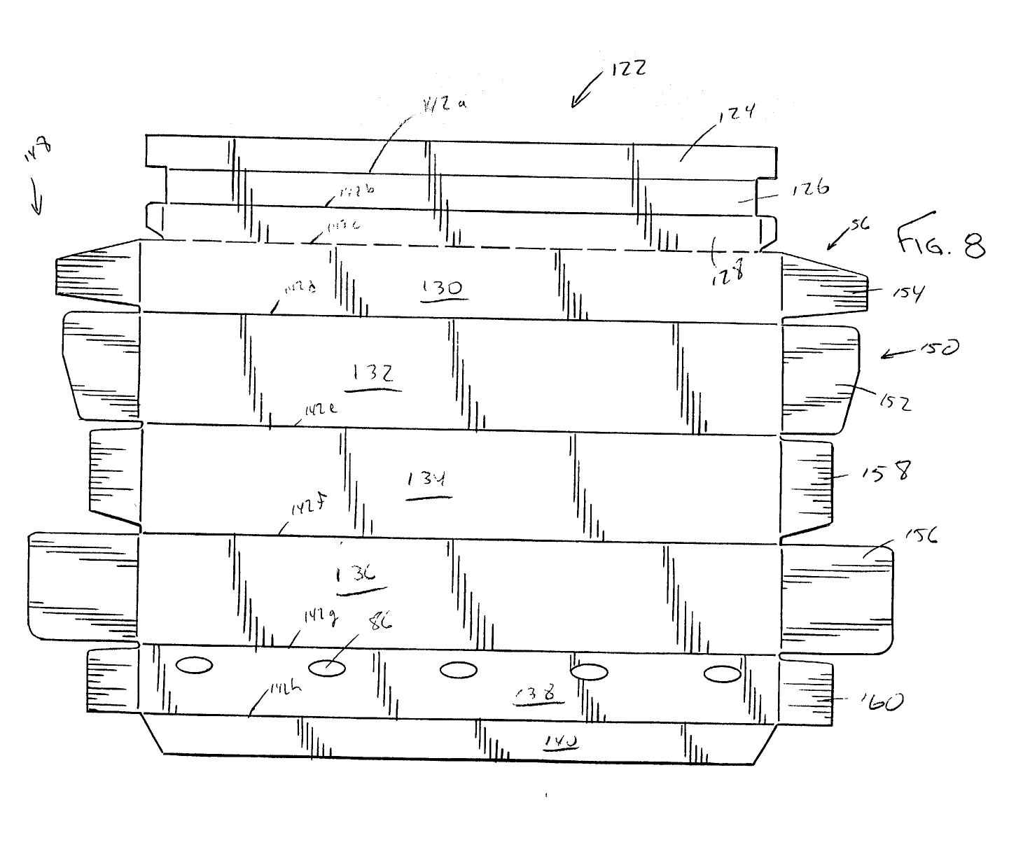

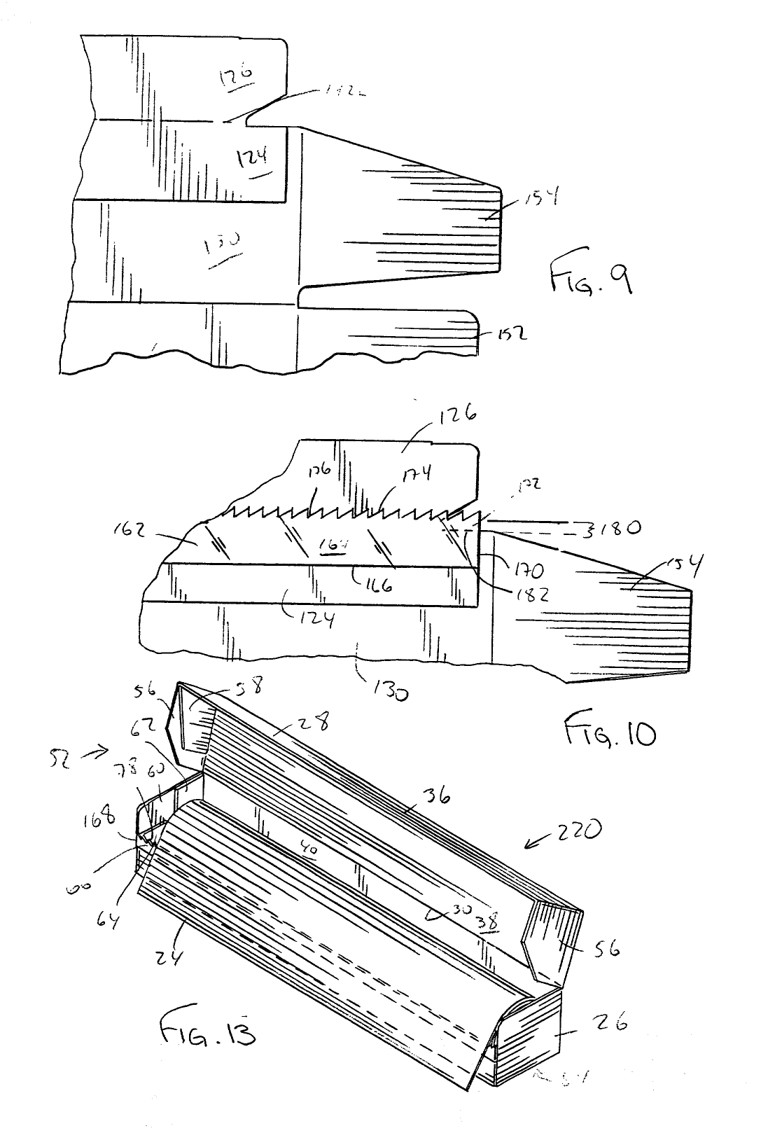

Referring now to FIG. 4, a plan view of a template 32 which may be used in constructing the dispenser 20 is shown in detail. The template 32 may include, in adjoining and sequential fashion, a tear strip 34, a front lid flap 36, a top lid flap 38, a back base flap 40, a base bottom flap 42, a front base flap 44, and a front base reinforcing flap 46. As can be seen best from FIG. 4, each of the flaps 34-46 is separated by a crease or fold 48a-f, to facilitate formation of the template 32 into the dispenser 20. In addition, one of the folds, specifically fold 48a, is scored or perforated to facilitate removal of the tear strip 34 when it is desired to open the dispenser 20.

The template 32 also includes a plurality of end flaps 50 adapted to close first and second ends 52, 54 of the dispenser 20. More specifically, each of the ends 52, 54 include a lid major flap 56 and a lid minor flap 58, as well as a base major end flap 60, a base back end flap 62, and a base front end flap 64. The importance and sequence of assembly for the end flaps 50 will be discussed in further detail herein.

As shown best in FIGS. 3, 5, and 14, the dispenser 20 further includes a cutter bar 66. The cutter bar 66 may include a base 68 having a back edge 70, first and second end edges 72 and 74, and a front edge 76. A plurality of serrations or teeth 78 extend from the front edge 76 and are each separated by a plurality of valleys 80. More specifically, it will be noted that each tooth 78 includes first and second flanking sides 82, 84 and at the front edge 76 of the base 68. It is the first and second flanking sides 82, 84 of adjacent teeth which meet at the front edge 76 to define each valley 80. The cutter bar 66 may be attached to the base bottom flap 42 such that the valleys 80 are each spaced from the fold 48e by a registration zone 81, the importance of which will be described in further detail herein.

As depicted in FIG. 14, the teeth 78 of the cutter bar 66 may extend from the cutter bar 66 in multiple directions. For example, the teeth 78 proximate the first edge 72 may extend in a leftward direction, while the teeth 78 proximate the second end edge 74 may extend in a rightward direction, and the teeth 78 provided centrally on the cutter bar 66 may extend orthogonally from the base 68. In so doing, it will be understood that the teeth 78 in such an embodiment form distinct cutting zones A, B, C to facilitate cutting the film 24. More specifically, it has been found that certain films 24 are more easily severed if the teeth 78 puncture the film 24 when the user pulls the film 24 against the cutter bar 66. By providing teeth 78 which are angled to the left and/or the right, the teeth 78 are ensured of penetrating and puncturing the film 24 regardless of the initial direction from which the user pulls the film 24. Moreover, by providing a central zone B having teeth 78 which are orthogonal to the base 68, a smooth transition between zones is assured to thereby avoid any snags or interruptions in cutting.

In alternative embodiments, it is to be understood that the teeth 78 can be provided so as to extend from the base 68 in alternative configurations including, but not limited to, configurations wherein each of the teeth 78 extend orthogonally from the base 68, each of the teeth 78 extend in a leftward direction, or each of the teeth 78 extend in a rightward direction. In the depicted embodiment, the cutter bar 66 is manufactured of polyethylene teraphthlyte (PET), but it is to be understood that the cutter bar 66 can be manufactured from alternative materials including other forms of plastics, as well as metals.

The front base flap 44 may be provided with a plurality of scored spots 86 adapted to receive adhesive thereon as shown best in FIG. 8. The adhesive (not shown) is provided to secure the tear strip 34 during initial construction, while the spots 86 are scored to enable the tear strip 34 to be removed when opening the dispenser 20 without the adhesive between the two tearing the exterior surface of the typically paperboard front flap 44 away and in an unaesthetic fashion.

In certain situations, it may be desirable to provide the cutter bar in an alternative position, for example on the lid. Referring now to FIGS. 6-11, such an alternative embodiment of a dispenser 120 is shown in detail. The dispenser 120 maybe constructed from a template 122 (FIG. 8) which may include, in adjoining and sequential fashion, a lid reinforcing flap 124, an interior tear strip 126, an exterior tear strip 128, a front lid flap 130, a top lid flap 132, a back base flap 134, a bottom base flap 136, a front base flap 138, and a front base reinforcing flap 140. As can be seen best in FIG. 8, each of the flaps 124 through 140 is separated by a crease or fold 142a-h to facilitate formation of the template 122 into the dispenser 120. In addition, one of the folds 142, specifically fold 142c, is scored or perforated to facilitate removal of the tear strip 144 formed by both the interior tear strip 126 and exterior tear strip 128 when it is desired to open the dispenser 120.

The template 122 also includes a plurality of end flaps 56 adapted to close first and second ends 148, 150 of the dispenser 120. More specifically, each of the ends 148 and 150 includes a lid major flap 152 and a lid minor flap 154, as well as a trunk major end flap 156, a trunk back end flap 158, and a trunk front end flap 160.

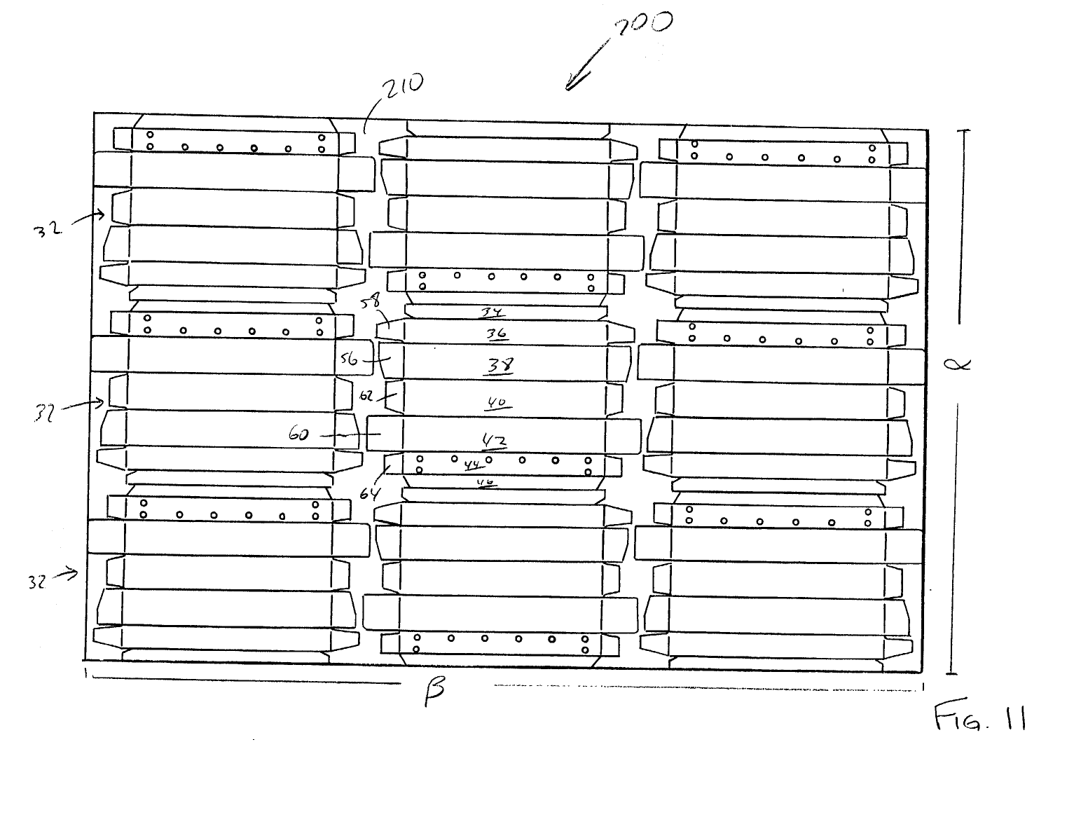

As shown best in FIGS. 7 and 10, the dispenser 120 further includes a cutter bar 162. The cutter bar 162 includes a base 164 having a back edge 166, first and second end edges 168 and 170 and a front edge 172. The front edge 172 includes a plurality of serrations or teeth 174 separated by a plurality of valleys 176. As with the first embodiment, the teeth 174 may extend from the cutter bar 162 in a single or multiple directions.

As with the first embodiment, an important feature with respect to the application of the cutter bar 162 to the reinforcing flap 124 concerns the relative positioning, or registration, of the cutter bar 162. As depicted best in FIG. 10, the cutter bar 162 is preferably attached such that the base 164 is attached to the reinforcing flap 124, but with the teeth 174 overlying the interior tear strip 126. In so doing, when the tear strip 144 is removed by the user, each of the teeth 174 are fully exposed and not blocked by the reinforcing flap 124, thereby improving the effectiveness of the cutter bar 162. In one embodiment, the cutter bar 162 is registered to provide a spacing of at least 1/32 (0.03125) of an inch in a registration zone 180, defined herein as the spacing between the valleys 176 and a bottom edge 182 of the interior tear strip 126. It is to be understood that other dimensions are certainly possible and within the scope of the disclosure, with a range of 0.01 to 0.05 inches being exemplary.

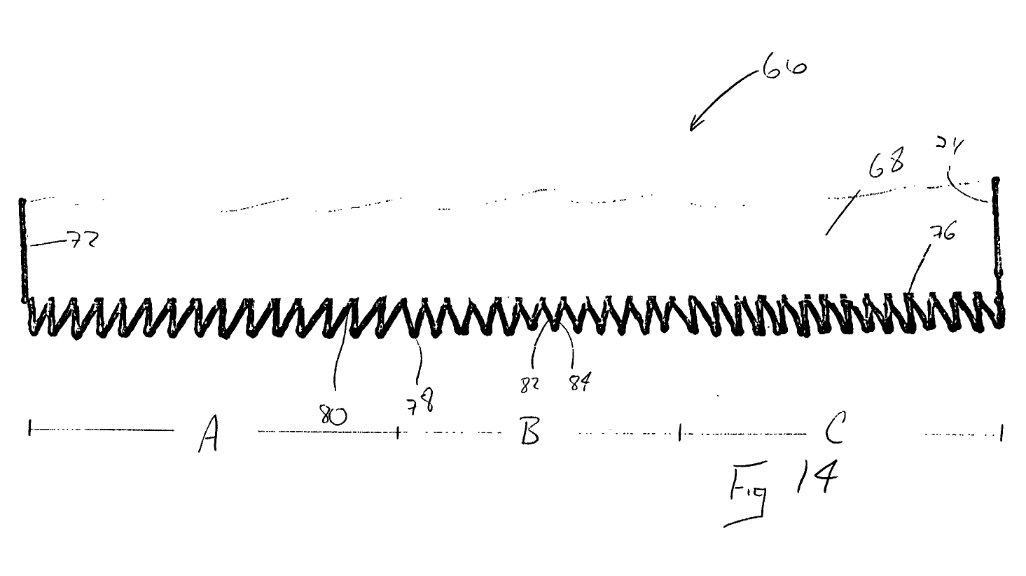

In a still further embodiment, the cutter bar 66 may be alternatively positioned. For example, as shown in FIG. 13, the cutter bar 66 may be positioned on the base front flap 44 such that the cutter bar teeth 78 extend vertically upwardly when the dispenser 220 is opened. It is to be understood that in such an embodiment, as well as others embodied within the present disclosure, it is important to mount the cutter bar 66 to have the registration zone disclosed above.

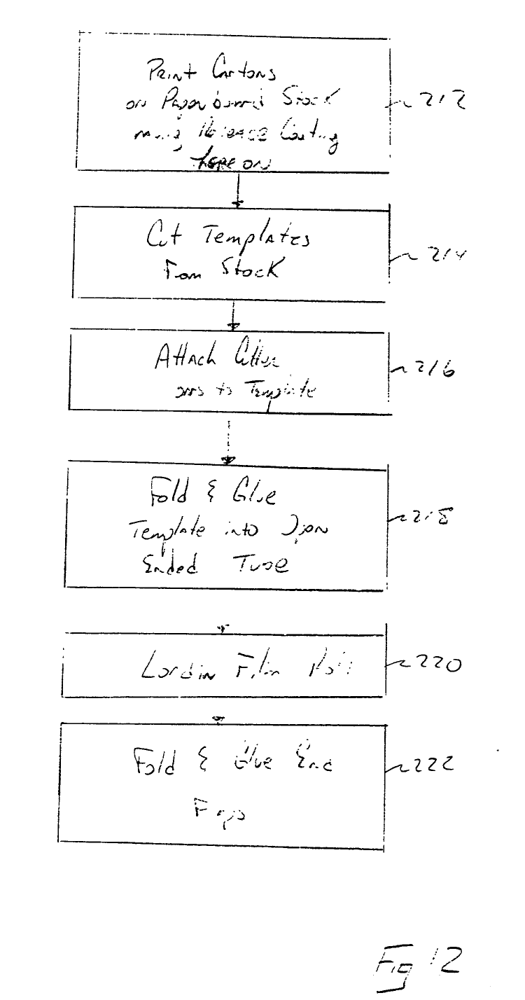

A method by which the dispenser 20 can be manufactured is described in conjunction with the flow chart of FIG. 12, as well as the other figures. Starting with FIG. 11, a sheet of stock material 200, such as paperboard, is depicted with a plurality of templates 32 outlined thereon for the purpose of illustration. Such a figure depicts the fact that, using the teachings of the disclosure, nine such templates 32 can be stamped or otherwise removed from a conventionally-sized stock sheet 200. Conventionally, the stock sheets 200 are provided in the form of paperboard having a width dimension α of 34 inches, and a length dimension β of 49¾ inches. Such precision translates directly into substantial cost savings for the manufacturer and user in that relatively little waste material 210 is produced for recycling purposes.

Turning now to FIG. 12, a first step 212 may be to print text and graphics (not shown) on the stocksheet 200. The stocksheet 200 may be provided with a release coating already thereon, the importance of which will be described in further detail herein. The release coating may be applied only to the front lid flap 130, but it is to be understood that in alternative embodiments, the entire template 32, except for the bottom base flap 136, could be coated with release coating. Suitable release coatings or varnishes which can be employed are that provided by Wikoff, under model number V77, as well as those provided by Flint, under part numbers P064L or 00-60869.

A next step 214 may be to stamp or otherwise cut the templates 32 from the stocksheet 200. Prior to assembly of the overall dispenser 20, a next step 216 may be to attach the cutter bar 66 to the base bottom flap 42. The cutter bar 66 is preferably attached thereto using a conventional adhesive. Typically, the cutter bar 66 would be provided in roll or tape form, precoated with adhesive, and cut and adhered to the template 32. Here the release coating is of importance in that since the entire surface of the cutter bar 66 is coated with an adhesive, the cutter bar 66 would be attached not only to the base bottom flap 42, but also to the bottom front flap 44, if not for the application of the release coating. This would be problematic in that once bottom front flap 44 were to be folded at fold 48e, the fibers from the paperboard material of the bottom front flap 44 would rip and remain attached to the teeth 78 of the cutter bar 66. Not only would such a process result in an unappealing or unaesthetic cutter bar 66, but the actual fibers attached to the cutter bar 66 would detrimentally affect the efficiency with which the cutter bar 66 could operate in severing the film 24 of the roll 22.

Once the cutter bar 66 is attached in the step 216, the template 32 may be manipulated in a folding and gluing process into a tubular configuration, as indicated in a step 218. More specifically, the template 32 is folded in 90° angles at each of the folds 52b-e, and at 180° at the fold 52f. Adhesive is then applied at the spots 86, with the tear strip 34 being thereby attached to the trunk front flap 48.

Once the template 32 is folded and adhered into such a tubular configuration, it will be noted that the ends 58 and 60 of the dispenser 20 are still open to enable the roll 22 of film 24 to be loaded therein. In certain operations, the folded and adhered dispenser 20 can be stored or transported to a separate production facility for insertion of the roll 22 or, alternatively, be used at the same facility manufacturing the rolls 22. In either event, the rolls 22 can be loaded through one of the ends 58, 60 as indicated in a step 220. Each of the ends 58 and 60 are then folded and glued closed as indicated in a step 222. More specifically, as will be understood by one of ordinary skill in the art, each of the trunk back end flaps and trunk front end flaps 62 and 64, respectively, are folded inwardly with the trunk major end flap 60 then being folded upwardly and adhered thereto to close the ends of the trunk 26. Similarly, the minor lid end flap 58 is then folded inwardly with the major lid end flap 56 then being folded downwardly and adhered thereto to close the ends of the lid 28 and thereby complete the dispenser 20.

From the foregoing, it will be noted that the teachings of the disclosure can be employed to create a dispenser for rolls of film material.

What is claimed is:

1. A wraps dispenser, comprising:
a trunk;
a lid hinged to the trunk;
a cutter bar having a base from which a plurality of teeth extend, each tooth terminating on first and second sides at a valley proximate the base, the base being attached to one of the trunk and the lid, each valley being spaced away from the trunk or lid to which the base is attached by a predetermined registration zone.

2. The wraps dispenser of claim 1, wherein the registration zone is within the range of about 0.01 to 0.05 inches.

3. The wraps dispenser of claim 1, wherein the registration zone has a width of approximately 0.03125 inches.

4. The wraps dispenser of claim 1, wherein the cutter bar is attached to a bottom surface of the trunk.

5. The wraps dispenser of claim 1, wherein the cutter bar is attached to a front surface of the lid.

6. The wraps dispenser of claim 1, wherein the front surface of the lid includes means for reinforcing the front surface of the lid.

7. The wraps dispenser of claim 1, wherein the trunk and lid are formed from a unitary piece of paperboard, the front surface of the lid including first and second pieces of paperboard.

8. A wraps dispenser, comprising:
a trunk having a base, a back wall, a front wall, and first and second end walls;
a lid hinged to the trunk, the lid having a front wall, a top wall, and first and second end walls;
a reinforcing member operatively associated with the lid front wall;
a tear strip removably attached to the lid front wall at a score line; and
a cutter bar attached to the reinforcing member, the cutter bar having a plurality of teeth separated by a plurality of valleys, the plurality of teeth overlying the tear strip, the plurality of valleys each being spaced from the tear line by a registration zone of predetermined dimension.

9. The wraps dispenser of claim 8, wherein the registration zone has a width dimension of at least 0.03125 inches.

10. The wraps dispenser of claim 8, wherein the reinforcing member is integral with the lid front wall.

11. A wraps dispenser, comprising:
a trunk adapted to receive a roll of wrap therein; and
a lid hinged to the trunk, the lid having a front flap to which a cutter bar is attached, the front flap of the lid being thicker than the trunk and remaining portions of the lid.

12. The wraps dispenser of claim 11, wherein the lid front flap includes first and second layers.

13. The wraps dispenser of claim 11, wherein the trunk and lid are made of paperboard and wherein the first and second layers of the lid are made by folding the paperboard.

14. The wraps dispenser of claim 11, wherein the lid further includes a tear strip adjacent the front flap, the tear strip being adhered to a front flap of the base.

15. The wraps dispenser of claim 11, wherein the tear strip includes a release coating to inhibit adhesion of the cutter bar to the tear strip.

16. The wraps dispenser of claim 11, wherein the cutter bar is made of plastic.

17. The wraps dispenser of claim 16, wherein the cutter bar is made of polyethylene terephthalate (PET).

18. The wraps dispenser of claim 14, wherein the tear strip is joined to the lid front flap at a score line, and the cutter bar includes a plurality of teeth separated by a plurality of valleys, each valley being spaced from the score line by at least 0.03125 inches.

19. The wraps dispenser of claim 11, wherein the trunk and lid are made from a unitary piece of material.

20. A method of forming a wraps dispenser, comprising:
providing a template having a plurality of lid flaps adapted to form a lid and a plurality of trunk flaps adapted to form a trunk;
attaching a cutter bar to the template, the cutter bar having a base from which a plurality of teeth extend, the base and the teeth overlying separate template flaps;
folding the flaps into a tubular configuration with open first and second ends adapted to receive a roll of film, the teeth being fully exposed after the folding step.

21. The method of claim 20, wherein the template includes a tear strip, a lid front flap, a lid top flap, a trunk back flap, a trunk bottom flap, a trunk front flap, a trunk reinforcing flap, and a plurality of end flaps, the cutter bar base being attached to the trunk bottom flap.

22. The method of claim 20, further including the steps of inserting a roll of film into the dispenser through one of the first and second ends, and closing the first and second ends with the plurality of end flaps.

23. The method of claim 20, further including the step of applying a release coating to the template.

24. The method of claim 20, further including the step of coating the cutter bar with adhesive prior to the attaching step.

25. The method of claim 20, wherein the providing step involves cutting the template from a sheet of paperboard.

26. The method of claim 25, wherein the sheet of paperboard is thirty-four inches wide and forty-nine and three-quarter inches long, and wherein nine templates are cut from each sheet.

27. A wraps dispenser, comprising:
a trunk adapted to receive a roll of film;
a lid hinged to the trunk and adapted to close the trunk;
a cutter bar attached to the dispenser; and
means for reinforcing the dispenser proximate the cutter bar.

28. The wraps dispenser of claim 27, wherein the cutter bar is attached to the dispenser lid.

29. The wraps dispenser of claim 27, wherein the means for reinforcing is a double-layered wall.

30. The wraps dispenser of claim 27, wherein the trunk-lid and means for reinforcing are all formed from a unitary piece of material.
